(19) United States
(12) Patent Application Publication
(10) Pub. No.: US 2014/0060258 A1
(43) Pub. Date: Mar. 6, 2014

(54) RATCHETED WRENCH HAND TOOL

(71) Applicant: STUART C. ANDERS, SUN PRAIRIE, WI (US)

(72) Inventor: STUART C. ANDERS, SUN PRAIRIE, WI (US)

(21) Appl. No.: 13/604,691

(22) Filed: Sep. 6, 2012

(51) Int. Cl. B25B 13/46

(52) U.S. Cl. 81/60

(57) ABSTRACT

A ratcheted wrench hand tool comprises a capability of rotationally driving a fastener when the tool's handle is off axis from the center line of the ratchet member. The hand tool comprises at least one gimbal ring to permit deflection of the tool's handle from the central axis line. Even when the handle is deflected from the central axis line, a user can nevertheless tighten or loosen a fastener by rotating the handle.

### BACKGROUND OF THE INVENTION

1. Field of the Invention

The field of the present invention relates to ratcheted wrench hand tools. More specifically, the present invention is directed to a wrench capable of rotationally driving a fastener when the wrench's handle is substantially off axis relative to the ratchet member.

2. Background of the Invention

Wrenches have been widely used and most of them are limited in function, especially when the fastener to be loosened or tightened is located in a difficult-to-access area. Pivoting wrenches are well known to accommodate, in part, difficult-to-access areas whereby the handle of such wrench can be rotated to drive the fastener, but this can only be accomplished when the hand is substantially inline with the axis of it and the ratchet drive member. The prior art pivoting wrench handle can be angled away from the center axis defined by the handle and the ratchet driving member in order to drive the fastener, so long as there is sufficient space to allow the handle to be deflected, and to engaged by the user in a clockwise or counterclockwise motion relative to the fastener. However, once a user deflects the handle of a pivoting wrench, the wrench is no longer capable of driving the fastener rotationally. There are situations in which there is insufficient space to allow a pivoting wrench handle to be deflected and if deflected, to be moved clockwise or counterclockwise relative to the fastener by the user in order to drive the fastener.

### SUMMARY OF THE INVENTION

It is the primary object of the present invention to provide a ratcheted wrench hand tool that is capable of rotationally driving a fastener when the tool's handle is off axis from the center line of the ratchet member. The hand tool comprises at least one gimbal ring to permit deflection of the tool's handle and thereby allows the user to tighten or loosen a fastener by angling the handle without losing rotational driving means capability.

It is another object of the present invention to provide a wrench handle that is not directly pivotally connected to a ratchet drive member.

It is still yet another object of the present invention to provide a ratcheted wrench hand tool that has a wand as its handle.

It is still yet a further object of the present invention to provide a ratcheted wrench hand tool that as a finger grip as its handle.

It is another object of the present invention to provide a ratcheted wrench hand tool with a plurality of gimbal rings as means to connect the ratchet member with the handle.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a ratcheted wrench hand tool of the present invention showing a finger grip handle;

FIG. 2 is an exploded perspective view of the ratcheted wrench hand tool of the present invention;

FIG. 3 is a perspective view of the ratcheted wrench hand tool of the present invention showing a wand handle;

FIG. 4A is a perspective view of the ratcheted wrench hand tool of the present invention showing the wand handle in line along the central axis, A, relative to the ratchet member.

FIG. 4B is a perspective view of the ratcheted wrench hand tool of the present invention showing the wand handle deviating more than 0 degrees and less than 90 degrees from the central axis, line A, of FIG. 4A; and

FIG. 4C is a perspective view of the ratcheted wrench hand tool of the present invention showing the wand handle deviating more than 90 degrees from the central axis, line A, of FIG. 4A

### DETAILED DESCRIPTION OF A PREFERRED EMBODIMENT

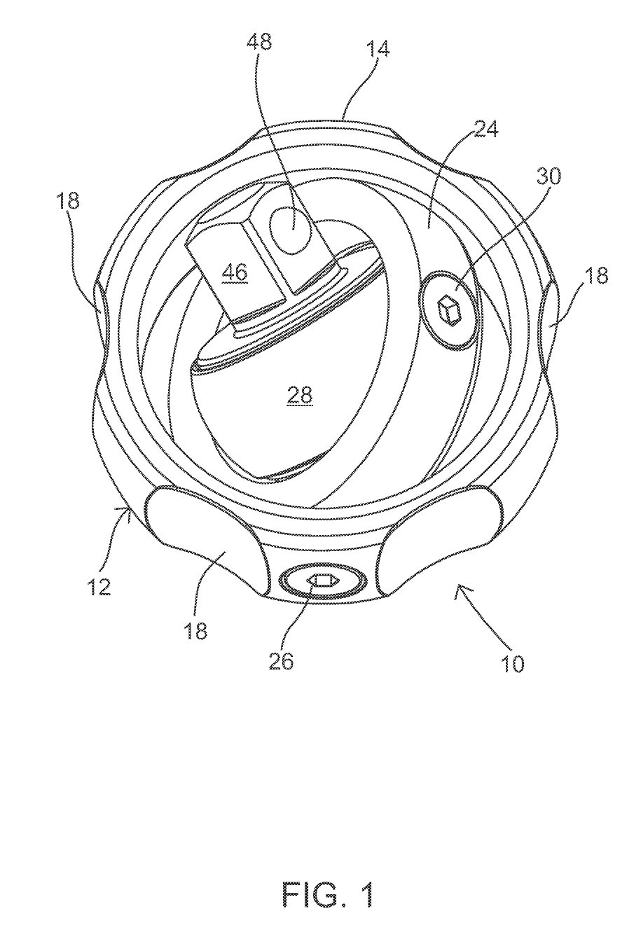

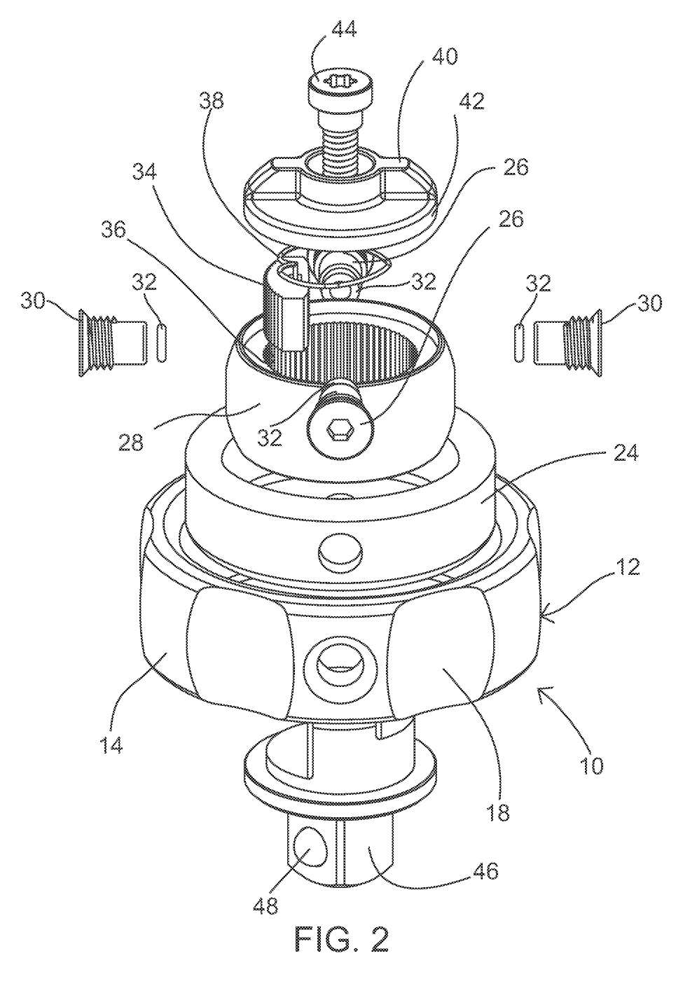

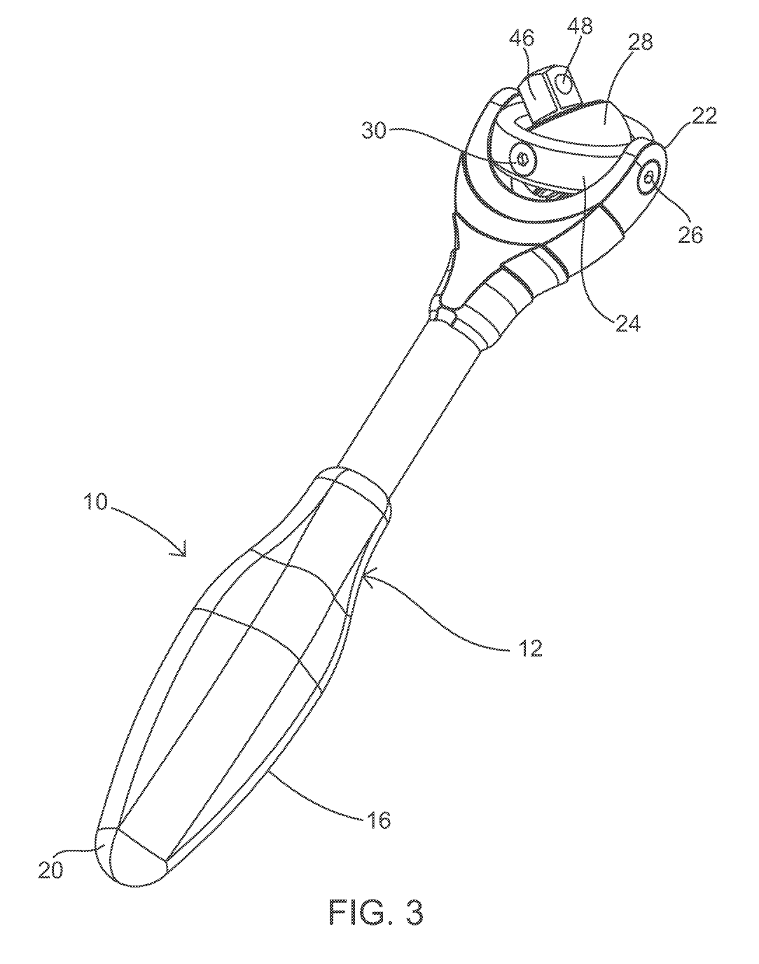

Referring to FIGS. 1-3, a ratchet wrench 10 in accordance with the present invention comprises a handle 12. In one form of a preferred embodiment of the present invention, FIGS. 1 and 2 show the handle 12 as a finger grip 14, and in FIG. 3 as a wand 16. The finger grip 14 has at least one grove 18 for allowing a user's finger to grasp the handle 12. However, as shown in FIGS. 1 and 2, a plurality of grooves, specifically, six in number, are shown. The handle 12 of the wand 16 type has a distal end 20 and a proximal end 22, whereby the distal end 20 permits a user to grasp the wrench 10.

The handle 12 is pivotally connected to a fully annular gimbal ring 24 through fastening means such as a set of pins or screws 26. For the wand type 16 of handle 12, the pivotal connection of the gimbal ring 24 to the handle 12 occurs at its proximal end 22. A ratchet member 28 is disposed interior of the gimbal ring 24 and is pivotally connected thereto by another set of fastening pins or screws 30. A friction-engaging member, such as a washer, gasket or o-ring 32 is optionally inserted into the screw holes that accept screws 26 and 30 to ensure a smooth functioning relationship between the each of the respective components of the wrench 10. The handle 12 to gimbal ring 24, and gimbal ring 24 to ratchet member 28 are orthogonally and pivotally connected about the pivot axes via the sets of fasteners 26 and 30. The Figures show one gimbal ring 24 connected to the handle 12, and, thus, the sets of fastening pins or screws, 26 and 30, are connected at 90 degree angles relative to their pivot axes. While only one gimbal ring 24 is shown in the Figures, the present invention includes a set or plurality of gimbal rings 24. For example, if the wrench 10 is comprised of two gimbal rings 24, the second one would be disposed to the interior of the first, and then the ratchet member 28 would be connected within the second ring. The sets of fastening members, from the handle to the outermost gimbal ring, and then from the outermost gimbal ring to the second or inner gimbal ring, and finally from the innermost gimbal ring to the ratchet member would be disposed at pivot axes having a 60 degree orthogonal relationship. Pivotally connecting a third innermost gimbal ring between the second gimbal ring and the ratchet member would dispose the pivot axes at 45 degrees, and so forth.

Referring now to FIG. 2, the ratchet member 28, comprises a pawl 34 mounted within a ratchet wheel cavity 36. On top of the pawl 34 is a biasing member or spring 38, for engaging a direction change lever 40 of the ratchet member cover 42. A screw 44 secures the direction change lever 40, which is a top component of a cover 42, to the ratchet member 28, and additionally, the ratchet member 28 to its drive 46. Accordingly, the lever 40, cover 42 and screw 44 on the one hand, and the drive 46 on the other, are on opposite ends of the wheel cavity 36. The drive 46 further comprises a detentable ball 48 and spring (not shown) for releaseable engagement with a fastening device such as a socket member (not shown).

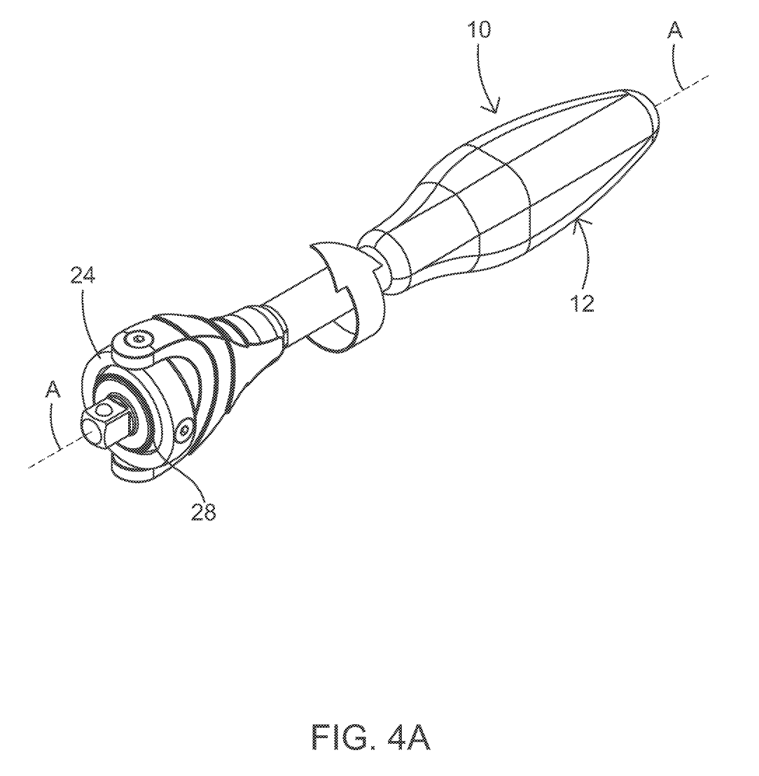

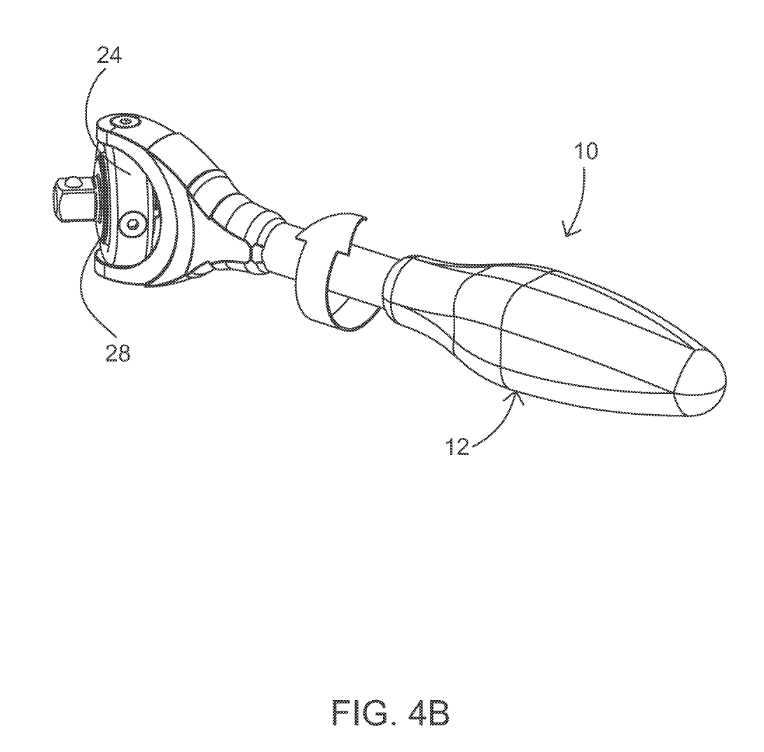

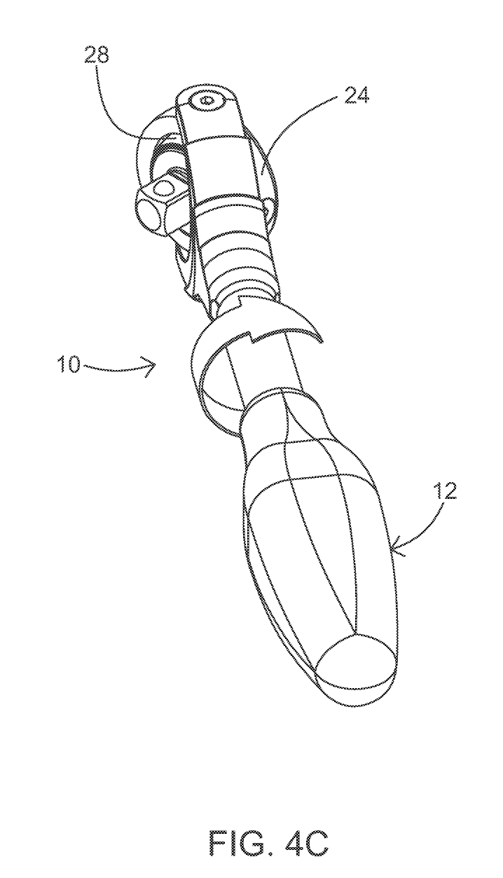

Referring now to FIGS. 4A, 4B and 4C, the present wrench 10 invention is shown in diagrammatic rotational operation. FIG. 4A depicts the wrench 10 such that the handle 12 is in line with the central axis, line A, defined by the handle 12 and the ratchet member 28. In this configuration, the wrench 10, as well as prior art, can rotate in the direction of the arrow and tighten a fastener (not shown). Counterclockwise rotation, of course, loosens the fastener.

However, unlike prior art pivot wrenches, when the handle 12 deviates from the in line relative to the ratchet member 28, rotational driving of the fastener is still possible. As shown in FIG. 4B, the handle 12 can deviate from an in line position of the handle 12 relative to the ratchet member 28 from greater than 0 degrees to less than 90 degrees and still be capable of driving a fastener by rotating the handle 12. As shown in FIG. 4C, the handle 12 can deviate from an in line position of the handle 12 relative to the ratchet member 28 at an angle greater than 90 degrees and still be capable of driving a fastener by rotating the handle 12. Theoretically, “gimbal lock” might occur where the handle 12 is 90 degrees, or perpendicular, measured from the central axis, line A, of the ratchet member 28, resulting no capability of driving a fastener. However, this “lock” is released by incorporating more than one gimbal ring 24 into the wrench 10 as described above.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

I claim:

1. A ratcheted wrench hand tool, comprising:
a handle;
a gimbal ring orthogonally and pivotally connected to said handle;
and a ratchet member dispose interiorly of said gimbal ring and orthogonally and pivotally connected to said gimbal ring.

2. A ratcheted wrench hand tool of claim 1, wherein the handle comprises a finger grip.

3. A ratcheted wrench hand tool of claim 1, wherein the handle comprises a wand.

4. A ratcheted wrench hand tool of claim 3, wherein said wand has a distal end and a proximal end such that the proximal end is orthogonally and pivotally connected to said gimbal ring.

5. A ratcheted wrench hand tool of claim 1, wherein the ratchet member terminates in a ratchet drive for releaseable engagement with securing a fastening device.

6. A ratcheted wrench hand tool of claim 1, wherein the gimbal ring is fully annular.

7. A ratcheted wrench hand tool, comprising:
a handle;
a set of gimbal rings comprising an outermost gimbal ring and an innermost gimbal ring wherein the outermost gimbal ring is orthogonally and pivotally connected to said handle;
and a ratchet member dispose interiorly of said innermost gimbal ring and orthogonally and pivotally connected to said innermost gimbal ring.

8. A ratcheted wrench hand tool of claim 7, wherein the handle comprises a finger grip.

9. A ratcheted wrench hand tool of claim 7, wherein the handle comprises a wand.

10. A ratcheted wrench hand tool of claim 9, wherein said wand has a distal end and a proximal end such that the proximal end is orthogonally and pivotally connected to said gimbal ring.

11. A ratcheted wrench hand tool of claim 7, wherein the ratchet member terminates in a ratchet drive for releaseable engagement with securing a fastening device.

12. A ratcheted wrench hand tool of claim 7, wherein the gimbal ring is fully annular.

13. A ratcheted wrench hand tool of claim 7, wherein the set of gimbal rings comprises at least two gimbal rings.

14. A ratcheted wrench hand tool of claim 13, wherein each gimbal ring is disposed interior of the next outer gimbal ring and where all said gimbal rings are orthogonally and pivotally connected to each adjacent gimbal ring.

15. A ratcheted wrench hand tool, comprising:
a handle;
a ratchet member having a central axis that is in line with said handle;
means for rotating said ratchet member when said handle is angularly displaced from said central axis, said means comprising at least one gimbal ring connected therebetween said ratchet member and said handle.

16. A ratcheted wrench hand tool of claim 15, wherein said ratchet member and said at least one gimbal ring are orthogonally and pivotally connected to each other.
